(19) United States
(12) Patent Application Publication
(10) Pub. No.: US 2025/0363678 A1
(43) Pub. Date: Nov. 27, 2025

(54) METHOD AND APPARATUS FOR GENERATING PET IMAGE, ELECTRONIC DEVICE AND STORAGE MEDIUM

(71) Applicant: Beijing Zitiao Network Technology Co., Ltd., Beijing (CN)

(72) Inventors: Yimeng ZHOU, Beijing (CN); Wenfeng LIN, Beijing (CN); Mingyu GUO, Beijing (CN); Jiao RAN, Beijing (CN)

(21) Appl. No.: 19/086,558

(22) Filed: Mar. 21, 2025

(30) Foreign Application Priority Data
May 23, 2024 (CN) 202410650399.1

(51) Int. Cl. G06T 11/00; G06V 10/774; G06V 40/10

(52) U.S. Cl. CPC G06T 11/00; G06V 10/774; G06V 40/10

(57) ABSTRACT

A method for generating a pet image is disclosed, the method including: obtaining a first text input by a user and a to-be-processed pet image input by the user, where the first text indicates a requirement for a to-be-generated target pet image, and the to-be-processed pet image includes a target pet for generating the target pet image. The first text is input into an image generation model. The image generation model includes a pre-trained first plug-in, and an image feature of the to-be-processed pet image is input into the first plug-in. The first plug-in may process the image feature. The image generation model may process an input text. In addition, the image generation model may interact with the first plug-in to generate the target pet image.

### CROSS-REFERENCE TO RELATED APPLICATION

This application claims the priority to and benefits of the Chinese Patent Application, No. 202410650399.1, which was filed on May 23, 2024. The aforementioned patent application is hereby incorporated by reference in its entirety.

### TECHNICAL FIELD

The present disclosure relates to the field of image processing and, in particular, to a method for generating a pet image, an electronic device, and a storage medium.

### BACKGROUND

With the development of artificial intelligence (AI) technology, the artificial intelligence technology may be used to generate images, for example, to generate artistic images for a person.

In some scenarios, users want to generate images for their pets, for example, to generate artistic images for their pets. However, the current AI technology is not effective in generating images for pets. Therefore, a solution is urgently needed to solve the above problem.

### SUMMARY

In order to solve or at least partially solve the above technical problem, embodiments of the present disclosure provide a method and apparatus for generating a pet image.

In a first aspect, an embodiment of the present disclosure provides a method for generating a pet image. The method includes: obtaining a first text input by a user and a to-be-processed pet image input by the user, where the first text indicates a requirement for a to-be-generated target pet image, and the to-be-processed pet image includes a target pet for generating the target pet image; inputting the first text into an image generation model, and inputting an image feature of the to-be-processed pet image into a pre-trained first plug-in of the image generation model, where the first plug-in is configured to process the image feature, and the image generation model is configured to interact with the first plug-in and process a text input into the image generation model, to generate the target pet image; and obtaining and outputting the target pet image output by the image generation model.

Optionally, the first plug-in includes: a pet head portrait plug-in, and/or a pet full body portrait plug-in, and the image feature of the to-be-processed pet image includes a head portrait feature and/or a full body portrait feature; the pet head portrait plug-in is configured to process the head portrait feature of the target pet; and the pet full body portrait plug-in is configured to process the full body portrait feature of the target pet.

Optionally, the pet head portrait plug-in is obtained by training as follows: training the pet head portrait plug-in by using a first training image, a description text of the first training image, and a first sub-image of the first training image, where the first training image is used as a training label, and the first sub-image includes a head image of the first training image or a head segmentation of the first training image, and the first training image is an image including a pet.

Optionally, the pet full body portrait plug-in is obtained by training as follows: training the pet full body portrait plug-in by using a second training image, a description text of the second training image, and a second sub-image of the second training image, where the second training image is used as a training label, and the second sub-image includes a full body image of the second training image or a full body segmentation of the second training image, and the second training image is an image including a pet.

Optionally, the pet head portrait plug-in and the pet full body portrait plug-in are obtained by training as follows: training the pet head portrait plug-in and the pet full body portrait plug-in by using a third training image, a description text of the third training image, and a third sub-image of the third training image, where the third training image is used as a training label, and the third sub-image includes a full body image of the third training image, a full body segmentation of the third training image, a head image of the third training image, or a head segmentation of the third training image, and the third training image is an image including a pet.

Optionally, the method further includes: identifying the to-be-processed pet image to determine a breed of the target pet; and supplementing the first text based on the breed of the target pet to obtain a second text; and the inputting the first text into an image generation model includes: inputting the second text obtained through supplementing the first text into an image generation model.

Optionally, the method further includes: obtaining an image style selected by the user, and determining a second plug-in corresponding to the image style, where the second plug-in is configured to control a style of the target pet image; and the image generation model is further configured to: when generating the target pet image, interact with the second plug-in to generate the target pet image.

Optionally, before the inputting the first text into an image generation model, and inputting an image feature of the to-be-processed pet image into a first plug-in of the image generation model, the method further includes: determining that the to-be-processed pet image does not include a human face.

Optionally, the to-be-processed pet image is a single pet image.

In a second aspect, an embodiment of the present disclosure provides an apparatus for generating a pet image. The apparatus includes: a first obtaining unit, configured to obtain a first text input by a user and a to-be-processed pet image input by the user, where the first text indicates a requirement for a to-be-generated target pet image, and the to-be-processed pet image includes a target pet for generating the target pet image; an input unit, configured to input the first text into an image generation model, and input an image feature of the to-be-processed pet image into a pre-trained first plug-in of the image generation model, where the first plug-in is configured to process the image feature, and the image generation model is configured to interact with the first plug-in and process a text input into the image generation model, to generate the target pet image; and an output unit, configured to obtain and output the target pet image output by the image generation model.

Optionally, the first plug-in includes: a pet head portrait plug-in, and/or a pet full body portrait plug-in, and the image feature of the to-be-processed pet image includes a head portrait feature and/or a full body portrait feature; the pet head portrait plug-in is configured to process the head portrait feature of the target pet; and the pet full body portrait plug-in is configured to process the full body portrait feature of the target pet.

Optionally, the pet head portrait plug-in is obtained by training as follows: training the pet head portrait plug-in by using a first training image, a description text of the first training image, and a first sub-image of the first training image, where the first training image is used as a training label, and the first sub-image includes a head image of the first training image or a head segmentation of the first training image, and the first training image is an image including a pet.

Optionally, the pet full body portrait plug-in is obtained by training as follows: training the pet full body portrait plug-in by using a second training image, a description text of the second training image, and a second sub-image of the second training image, where the second training image is used as a training label, and the second sub-image includes a full body image of the second training image or a full body segmentation of the second training image, and the second training image is an image including a pet.

Optionally, the pet head portrait plug-in and the pet full body portrait plug-in are obtained by training as follows: training the pet head portrait plug-in and the pet full body portrait plug-in by using a third training image, a description text of the third training image, and a third sub-image of the third training image, where the third training image is used as a training label, and the third sub-image includes a full body image of the third training image, a full body segmentation of the third training image, a head image of the third training image, or a head segmentation of the third training image, and the third training image is an image including a pet.

Optionally, the apparatus further includes: a first determining unit, configured to identify the to-be-processed pet image to determine a breed of the target pet; and a supplement unit, configured to supplement the first text based on the breed of the target pet to obtain a second text; and the input unit is configured to: input the second text obtained through supplementing the first text into the image generation model.

Optionally, the apparatus further includes: a second obtaining unit, configured to obtain an image style selected by the user, and determine a second plug-in corresponding to the image style, where the second plug-in is configured to control a style of the target pet image; and the image generation model is further configured to: when generating the target pet image, interact with the second plug-in to generate the target pet image.

Optionally, the apparatus further includes: a second determining unit, configured to: before inputting the first text into the image generation model and inputting the image feature of the to-be-processed pet image into the first plug-in of the image generation model, determine that the to-be-processed pet image does not include a human face.

Optionally, the to-be-processed pet image is a single pet image.

In a third aspect, an embodiment of the present disclosure provides an electronic device. The electronic device includes a processor and a memory. The processor is configured to execute instructions stored in the memory, to enable the electronic device to perform the method according to any one of the above first aspect.

In a fourth aspect, an embodiment of the present disclosure provides a computer-readable storage medium. The computer-readable storage medium includes instructions. The instructions indicate a device to perform the method according to any one of the above first aspect.

In a fifth aspect, an embodiment of the present disclosure provides a computer program product. When the computer program product runs on a computer, the computer is caused to perform the method according to any one of the above first aspect.

Compared with the prior art, the embodiments of the present disclosure have the following advantages:

Embodiments of the present disclosure provide a method for generating a pet image. The method includes: obtaining a first text input by a user and a to-be-processed pet image input by the user, where the first text indicates a requirement for a to-be-generated target pet image, and the to-be-processed pet image includes a target pet for generating the target pet image. Further, the first text is input into an image generation model. The image generation model includes a first plug-in that is pre-trained, and an image feature of the to-be-processed pet image may be input into the first plug-in. The first plug-in may process the image feature. The image generation model may process an input text. In addition, the image generation model may interact with the first plug-in to generate the target pet image. The image generation model has an image generation capability, and the first plug-in may process the image feature to guide the image generation model to generate the target pet image matching the target pet. Therefore, it can be learned that by using the solution of the embodiments of the present disclosure, the target pet image that meets the requirements of the user can be generated for the user.

### BRIEF DESCRIPTION OF DRAWINGS

In order to illustrate the technical solutions in the embodiments of the present disclosure or in the prior art more clearly, the following briefly introduces the drawings required for describing the embodiments or the prior art. Apparently, the drawings in the following description show merely some embodiments of the present disclosure, and a person of ordinary skill in the art may derive other drawings from these drawings without creative efforts.

FIG. 1 is a schematic flowchart of a method for generating a pet image according to an embodiment of the present disclosure;

FIG. 2 is a schematic flowchart of a method for generating a pet image according to an embodiment of the present disclosure;

FIG. 3 is a schematic flowchart of a method for training a pet head portrait plug-in according to an embodiment of the present disclosure;

FIG. 4 is a schematic flowchart of a method for training a pet full body portrait plug-in according to an embodiment of the present disclosure;

FIG. 5 is a schematic flowchart of a plug-in training method according to an embodiment of the present disclosure;

FIG. 6a is a schematic flowchart of a plug-in training method according to an embodiment of the present disclosure;

FIG. 6b is a schematic flowchart of another plug-in training method according to an embodiment of the present disclosure;

FIG. 7 is a schematic flowchart of another method for generating a pet image according to an embodiment of the present disclosure; and

FIG. 8 is a schematic diagram of a structure of an apparatus for generating a pet image according to an embodiment of the present disclosure.

### DETAILED DESCRIPTION

In order to enable those skilled in the art to better understand the solutions of the present disclosure, the technical solutions in the embodiments of the present disclosure will be described clearly and comprehensively below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

The inventors of the present disclosure have found through research that with the development of AI technology, the AI technology can already generate images of a person well. For example, the AI technology may generate a portrait image for a person by means of “face swapping”. Under the influence of the AI technology used to generate a portrait of a person, there is a need to generate an image (for example, a portrait) for a pet.

At present, the face swapping solution for generating a portrait for a person cannot be directly applied to generating an image for a pet, because facial information of a pet is different from that of a human face. The facial information of a pet includes not only five sense organs, but also information such as coat color and hair. Moreover, appearances of pets of different species and/or breeds vary greatly. Specifically, pets of different species and/or breeds may have great differences in coat color, eyes, ears, body shape, bones, and the like. A species of a pet is used to distinguish different pet species. For example, a cat and a dog are two different kinds of pets. The same kind of pets may include a plurality of breeds. For example, a dog may include Scottish Shepherd, Tibetan Mastiff, Samoyed, Golden Retriever, and other breeds.

The inventors of the present disclosure have found that pet images may be generated by using a Stable Diffusion model and a Low-Rank Adaptation of Large Language Models (LoRa) model at present.

The Stable Diffusion model is a generation model that is commonly used for AI drawing, and can generate a corresponding description-based or image-based new image through description text or image input.

To more effectively control the image content generated by the Stable Diffusion model, some fine-tuning technologies based on a large model have emerged, such as the aforementioned LoRa model, which can complete training with only a small number of samples. The LoRa model may be used in combination with the Stable Diffusion model to adjust the image generated by the Stable Diffusion model, so that the image generated by the Stable Diffusion model better meets the requirements of the user.

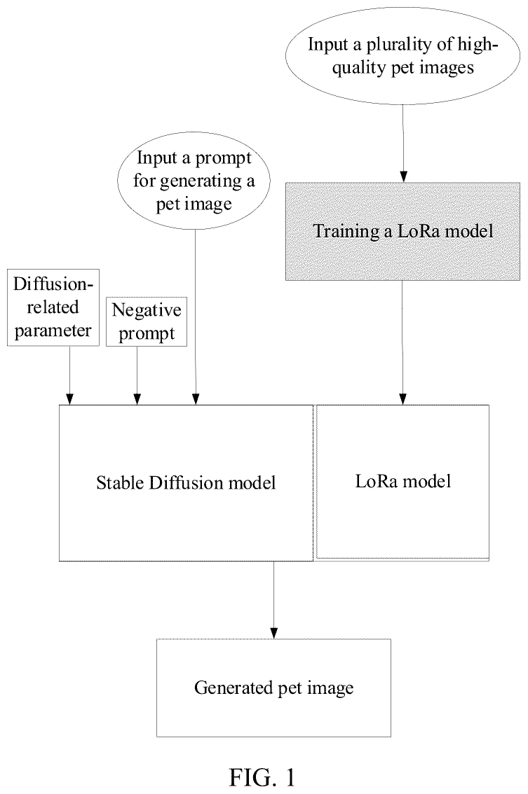

As a specific example, the process of generating a pet image by using the Stable Diffusion model and the LoRa model may be understood with reference to FIG. 1. FIG. 1 is a schematic flowchart of a method for generating a pet image according to an embodiment of the present disclosure.

As shown in FIG. 1, a user may input a plurality of high-quality pet images, and quickly train an LoRa model by using the plurality of pet images. In addition, the user may input a prompt for generating a pet image into the Stable Diffusion model. The prompt may be understood as a requirement for the to-be-generated pet image. For example, the prompt may be “a cat wearing a green sweater and a Christmas hat, surrounded by Christmas trees and gifts”. In an example, a negative prompt (for example, a negative prompt preset by the client) may also be input, and the negative prompt may be used to indicate content that cannot appear in the generated image of the pet. In another example, the user may also adjust the parameter of the aforementioned Stable Diffusion model as required, which will not be described in detail here.

The quickly trained LoRa model may guide the Stable Diffusion model to generate a pet image that is closer to the plurality of pet images input by the user based on the prompt input by the user. In this manner, the pet image that meets the requirements of the user can be generated.

In this manner, on the one hand, relatively strict requirements are imposed on the number and quality of pet images input by the user. The user is required to input a plurality of pet images, and the quality of the plurality of pet images is required to be relatively high. Generally, the user needs to clearly capture the pet images from multiple angles to obtain the aforementioned “a plurality of high-quality pet images”, which is difficult for the user to operate. On the other hand, the aforementioned “quickly training an LoRa model” (corresponding to the shaded box in FIG. 1) takes a long time, and generally takes a few minutes, resulting in a long time for generating the pet image.

In view of this, an embodiment of the present disclosure provides a method for generating a pet image. The method, on the one hand, imposes looser requirements on the pet images input by the user, and on the other hand, improves the efficiency of generating the pet images.

Various non-restrictive implementations of the present disclosure are described in detail below with reference to the drawings.

### Exemplary Method

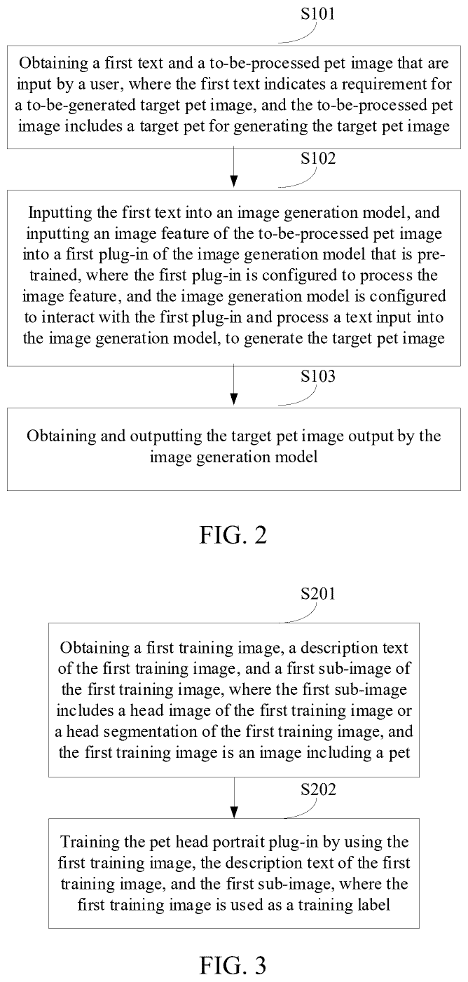

Referring to FIG. 2, FIG. 2 is a schematic flowchart of a method for generating a pet image according to an embodiment of the present disclosure. The solution provided in this embodiment of the present disclosure may be applied to a client or a server, which is not specifically limited in this embodiment of the present disclosure. In the following description of this embodiment of the present disclosure, an example in which the solution is applied to a client is used for description.

In this embodiment, the method may include the following steps S101 to S103.

In S101, obtaining a first text input by a user and a to-be-processed pet image input by the user, where the first text indicates a requirement for a to-be-generated target pet image, and the to-be-processed pet image includes a target pet for generating the target pet image.

In an example, the client may provide an image upload entry for the user, and the user may trigger a pet image upload operation through the image upload entry and upload the to-be-processed pet image. In this embodiment of the present disclosure, the user may upload one or more pet images as the to-be-processed pet image. In other words, in this embodiment of the present disclosure, there is no strict requirement on the number of pet images uploaded by the user, and the user may choose to upload only one pet image. In the case where the user uploads only one pet image, the target pet image that meets the requirements of the user can also be generated by using the solution provided in this embodiment of the present disclosure. In the case where the user uploads only one image, the aforementioned to-be-processed pet image is a single pet image. Certainly, the user may also choose to upload a plurality of pet images, which is not specifically limited in this embodiment of the present disclosure.

In an example, the to-be-processed image includes a target pet, and a species and a breed of the target pet are not specifically limited in this embodiment of the present disclosure. The target pet may be any kind of pet or any breed of pet.

In an example, the client may provide an input area for inputting a pet image generation requirement for the user, and the user may input the aforementioned first text in the input area according to the user's own requirement. The first text may indicate the pet image generation requirement of the user, and the pet image generation requirement may be understood as a requirement for the to-be-generated target pet image. In other words, the first text may be used to indicate the requirement for the to-be-generated target pet image. The first text is not specifically limited in this embodiment of the present disclosure, and the first text may be determined according to an actual situation. For example, the first text may be “a cat wearing a green sweater and a Christmas hat, surrounded by Christmas trees and gifts”.

In S102, inputting the first text into an image generation model, and inputting an image feature of the to-be-processed pet image into a first plug-in of the image generation model that is pre-trained, where the first plug-in is configured to process the image feature, and the image generation model is configured to interact with the first plug-in and process a text input into the image generation model, to generate the target pet image.

After the first text is obtained, the first text may be input into the image generation model. The image generation model mentioned here may be a model that is configured to generate a new image based on an input text and/or image. As a specific example, the image generation model may be a Stable Diffusion model.

In order to enable the target pet image generated by the image generation model to better meet the requirements of the user, a first plug-in that is used in conjunction with the image generation model may be pre-trained. The first plug-in is used in conjunction with the image generation model, and therefore, the first plug-in may also be considered as a plug-in of the image generation model. The first plug-in can process the image feature. The client can input the image feature of the to-be-processed pet image into the first plug-in, so that the first plug-in processes the image feature.

The image generation model can process an input text, for example, the first text, so as to generate the target pet image that meets the first text. In this embodiment of the present disclosure, the target pet image needs to not only meet the first text, but also be closer to the target pet in the to-be-processed pet image. To achieve this objective, the image generation model may interact with the first plug-in. As a specific example, the image generation model may obtain a processing result of the first plug-in on the image feature, so as to combine the processing result to generate the target pet image. Because the processing result is obtained based on the image feature of the to-be-processed pet image, the generated pet image can be closer to the target pet by combining the processing result to generate the target pet image.

The first plug-in is not specifically limited in this embodiment of the present disclosure, and the first plug-in may be any plug-in with an image feature processing function. As an example, the first plug-in may be, for example, an IP-Adapter, which is an effective and lightweight adapter that can process an image or an image feature input by the user and diffuse a processing result into the image generation model to guide the image generation model to better generate a new image closer to the image input by the user.

In a specific example, to enable the image generation model to better capture the feature of the target pet, the first plug-in may include a pet head portrait plug-in and/or a pet full body portrait plug-in.

The pet head portrait plug-in is configured to process a head portrait feature of the target pet. In the case where the first plug-in includes the pet head portrait plug-in, the image feature of the to-be-processed pet image includes the head portrait feature of the target pet. Correspondingly, in this scenario, the image generation model can better capture the head portrait feature of the target pet, so as to combine the head portrait feature of the target pet to generate the target pet image closer to the target pet. In an example, the pet head portrait plug-in may also be an IP-Adapter.

The pet full body portrait plug-in is configured to process a full body portrait feature of the target pet. In the case where the first plug-in includes the pet full body portrait plug-in, the image feature of the to-be-processed pet image includes the full body portrait feature of the target pet. Correspondingly, in this scenario, the image generation model can better capture the full body portrait feature of the target pet, so as to combine the full body portrait feature of the target pet to generate the target pet image closer to the target pet. In an example, the pet full body portrait plug-in may also be an IP-Adapter.

In an example, to make the generated target pet image closer to the target pet, the to-be-processed pet image may also be identified to determine the breed of the target pet. As an example, a traditional image identification technology may be used to identify the to-be-processed pet image to determine the breed of the target pet. As another example, a model capable of identifying a pet breed may also be trained, and the to-be-processed pet image is input into the model, so as to obtain the breed of the target pet.

After the breed of the target pet is determined, the first text may be supplemented based on the breed of the target pet to obtain a second text. The supplemented second text includes not only the original semantics of the first text, but also the breed of the target pet. For example:

The to-be-processed pet image input by the user is an image of a calico cat, that is, the breed of the target pet is: calico cat. The first text is “a cat wearing a green sweater and a Christmas hat, surrounded by Christmas trees and gifts”. The supplemented second text may be “a calico cat wearing a green sweater and a Christmas hat, surrounded by Christmas trees and gifts”. Correspondingly, in the scenario where the first text is supplemented to obtain the second text, the second text may be input into the image generation model, so that the image generation model interacts with the first plug-in and processes the second text to generate the target pet image.

In an example, the client may also provide an image style selection entry for the user. For example, the client may display a plurality of to-be-selected image styles, and the user selects one of the plurality of to-be-selected image styles. For ease of description, the image style selected by the user is referred to as a “target image style”. The client may generate a pet image that meets the target image style when generating the target pet image.

In this embodiment of the present disclosure, plug-ins respectively corresponding to the to-be-selected image styles may be pre-trained, and the plug-in corresponding to each to-be-selected image style may be used to interact with the image generation model to guide the image generation model to generate an image based on the corresponding to-be-selected image style.

Therefore, to generate the pet image that meets the target image style, the second plug-in of the image generation model may be used in specific implementation. The second plug-in may be a plug-in corresponding to the aforementioned target image style. After the user selects the target image style, the client may obtain the plug-in corresponding to the target image style as the second plug-in. As can be learned from the foregoing description of the plug-in corresponding to the to-be-selected image style, the second plug-in may be used to control the style of the target pet image. Specifically, the second plug-in may interact with the image generation model to guide the image generation model to generate the target pet image based on the target image style.

The to-be-selected image style is not specifically limited in this embodiment of the present disclosure, and the to-be-selected image style may be determined according to an actual situation. The second plug-in is not specifically limited in this embodiment of the present disclosure. In a specific example, the second plug-in may be, for example, an LoRa style control model.

In an example, to prevent the user from maliciously using a human face image to generate a pet image, before performing S102, the client may also perform face recognition on the to-be-processed pet image, and if it is determined that the to-be-processed pet image does not include a human face, continue to perform S102 and subsequent steps. Correspondingly, if it is determined that the to-be-processed pet image includes a human face, the client may no longer perform S102 and subsequent steps. Optionally, if the to-be-processed pet image includes a human face, the client may output prompt information, and the prompt information is used to prompt the user to re-upload a pet image.

In S103, obtaining and outputting the target pet image output by the image generation model.

After the image generation model generates the target pet image, the client may obtain the target pet image, and further output the target pet image. Outputting the target pet image may be, for example, displaying the target pet image on a page provided by the client.

In some embodiments, the target pet image displayed by the client may further support functions such as downloading (or saving) and forwarding, which will not be described in detail here.

It can be learned from the above description that by using the solution of the embodiment of the present disclosure, on the one hand, the user does not need to input a plurality of pet images, and the user may input only one pet image as the to-be-processed pet image, which is convenient for the user to operate. In addition, in the embodiment of the present disclosure, the first plug-in is pre-trained, and there is no need to “temporarily” train an auxiliary model (such as the LoRa model) based on the to-be-processed pet image input by the user. Therefore, the target pet image can be efficiently generated by using this solution.

As described above, the first plug-in is pre-trained, and the first plug-in may include the pet head portrait plug-in and/or the pet full body portrait plug-in.

Next, the training manners of the pet head portrait plug-in and the pet full body portrait plug-in are described separately.

Referring to FIG. 3, FIG. 3 is a schematic flowchart of a method for training a pet head portrait plug-in according to an embodiment of the present disclosure. The method shown in FIG. 3 may include the following steps of S201 to S202.

In this embodiment of the present disclosure, the pet head portrait plug-in may be trained by using a plurality of groups of training samples. When the pet head portrait plug-in is trained, the processing manner for each group of training samples is similar. Next, a training process of the pet head portrait plug-in is described by using one group of training samples as an example.

In S201, obtaining a first training image, a description text of the first training image, and a first sub-image of the first training image, where the first sub-image includes a head image of the first training image or a head segmentation of the first training image, and the first training image is an image including a pet.

In this embodiment of the present disclosure, the first training image, the description text of the first training image, and the first sub-image of the first training image may be used as a group of training samples. In an example, the first training image is an image including a pet, and the first training image may be, for example, an image obtained by capturing the pet at any angle. The description text of the first training image may include a plurality of texts used to describe the first training image, for example, it may include a description of factors such as a dressing, a manner, and an environment of the pet in the first training image.

In this embodiment of the present disclosure, the head image of the first training image may be an image including a head of the pet that is intercepted from the first training image, and the head image of the first training image may include some other image backgrounds in addition to the head of the pet. The head segmentation of the first training image may also be obtained by processing the first training image, and the head segmentation includes the head of the pet but does not include the image background in the first training image.

In S202, training the pet head portrait plug-in by using the first training image, the description text of the first training image, and the first sub-image, where the first training image is used as a training label.

After the first training image, the description text of the first training image, and the first sub-image of the first training image are obtained, the pet head portrait plug-in may be trained based on the first training image, the description text of the first training image, and the first sub-image. When the pet head portrait plug-in is trained, the first training image may be used as a training label.

In the process of training the pet head portrait plug-in, the pet head portrait plug-in may generate a first prediction image based on its own parameter, according to the description text of the first training image and the first sub-image. Further, the parameter of the pet head portrait plug-in is updated according to the first prediction image and the first training image that is used as the training label, so that the pet head portrait plug-in has stronger image generation capability. For example, if the first prediction image is regenerated by using the pet head portrait plug-in after the parameter is updated, the regenerated first prediction image may be closer to the first training image.

As an example, a loss function may be calculated based on the first prediction image and the first training image, and the parameter of the pet head portrait plug-in is updated based on the loss function.

When the number of parameter updates experienced by the pet head portrait plug-in is greater than a certain threshold, or when the loss function based on a certain group of training samples meets a certain condition (for example, close to 0), the pet head portrait plug-in is completely trained.

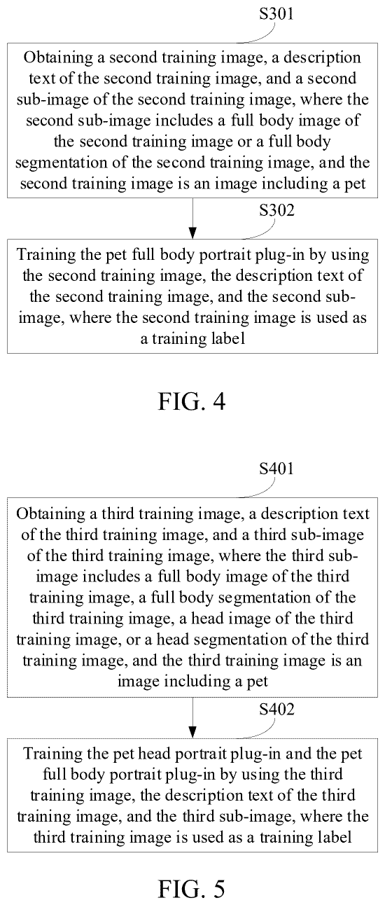

Referring to FIG. 4, FIG. 4 is a schematic flowchart of a method for training a pet full body portrait plug-in according to an embodiment of the present disclosure. The method shown in FIG. 4 may include the following steps of S301 to S302.

In this embodiment of the present disclosure, the pet full body portrait plug-in may be trained by using a plurality of groups of training samples. When the pet full body portrait plug-in is trained, the processing manner for each group of training samples is similar. Next, a training process of the pet full body portrait plug-in is described by using one group of training samples as an example.

In S301, obtaining a second training image, a description text of the second training image, and a second sub-image of the second training image, where the second sub-image includes a full body image of the second training image or a full body segmentation of the second training image, and the second training image is an image including a pet.

In this embodiment of the present disclosure, the second sub-image of the second training image may be the full body image of the second training image or the full body segmentation of the second training image. The full body image of the second training image may be an image including a full body of the pet that is intercepted from the second training image. The full body image of the second training image may include some other image backgrounds in addition to the full body of the pet. The full body segmentation of the second training image may also be obtained by processing the second training image, and the full body segmentation includes the full body of the pet but does not include the image background in the second training image.

In S302, training the pet full body portrait plug-in by using the second training image, the description text of the second training image, and the second sub-image, where the second training image is used as a training label.

After the second training image, the description text of the second training image, and the second sub-image are obtained, the pet full body portrait plug-in may be trained based on the second training image, the description text of the second training image, and the second sub-image. When the pet full body portrait plug-in is trained, the second training image may be used as a training label.

In the process of training the pet full body portrait plug-in, the pet full body portrait plug-in may generate a second prediction image based on its own parameter, according to the description text of the second training image and the second sub-image. Further, the parameter of the pet full body portrait plug-in is updated according to the second prediction image and the second training image that is used as the training label, so that the pet full body portrait plug-in has stronger image generation capability. For example, if the second prediction image is regenerated by using the pet full body portrait plug-in after the parameter is updated, the regenerated second prediction image may be closer to the second training image.

As an example, a loss function may be calculated based on the second prediction image and the second training image, and the parameter of the pet full body portrait plug-in is updated based on the loss function.

When the number of parameter updates experienced by the pet full body portrait plug-in is greater than a certain threshold, or when the loss function based on a certain group of training samples meets a certain condition (for example, close to 0), the pet full body portrait plug-in is completely trained.

In an example, the pet head portrait plug-in and the pet full body portrait plug-in may be trained in the same manner. In this scenario, the pet head portrait plug-in and the pet full body portrait plug-in may be a general plug-in obtained through training by using the method shown in FIG. 5. FIG. 5 is a schematic flowchart of a plug-in training method according to an embodiment of the present disclosure. The method shown in FIG. 5 may include the following steps of S401 to S402.

In S401, obtaining a third training image, a description text of the third training image, and a third sub-image of the third training image, where the third sub-image includes a full body image of the third training image, a full body segmentation of the third training image, a head image of the third training image, or a head segmentation of the third training image, and the third training image is an image including a pet.

For the full body image of the third training image and the full body segmentation of the third training image, reference may be made to the foregoing description of the full body image of the second training image and the full body segmentation of the second training image, and details are not described herein again.

For the head image of the third training image and the head segmentation of the third training image, reference may be made to the foregoing description of the head image of the first training image and the head segmentation of the first training image, and details are not described herein again.

In S402, training the pet head portrait plug-in and the pet full body portrait plug-in by using the third training image, the description text of the third training image, and the third sub-image, where the third training image is used as a training label.

After the third training image, the description text of the third training image, and the third sub-image are obtained, a general plug-in may be trained based on the third training image, the description text of the third training image, and the third sub-image, and the general plug-in may be used as the aforementioned pet head portrait plug-in or pet full body portrait plug-in. When the general plug-in is trained, the third training image may be used as a training label.

In the process of training the general plug-in, the general plug-in may generate a third prediction image based on its own parameter, according to the description text of the third training image and the third sub-image. Further, the parameter of the general plug-in is updated according to the third prediction image and the third training image that is used as the training label, so that the general plug-in has stronger image generation capability. For example, if the third prediction image is regenerated by using the general plug-in after the parameter is updated, the regenerated third prediction image may be closer to the third training image.

As an example, a loss function may be calculated based on the third prediction image and the third training image, and the parameter of the general plug-in is updated based on the loss function.

When the number of parameter updates experienced by the general plug-in is greater than a certain threshold, or when the loss function based on a certain group of training samples meets a certain condition (for example, close to 0), the general plug-in is completely trained.

In some scenarios, considering that for some pets, there may be a group of images, for example, a plurality of video frames are extracted from a video of a pet, and each video frame includes the certain pet. In this scenario, the group of images may all be used as training images to train the pet head portrait plug-in and the pet full body portrait plug-in.

In an example, the group of images includes a fourth training image and the aforementioned first training image, and the pet head portrait plug-in may also be trained by using the first training image, the description text of the first training image, and a fourth sub-image of the fourth training image, where the first training image is used as a training label. The fourth sub-image includes a head image of the fourth training image or a head segmentation of the fourth training image.

For the fourth sub-image, reference may be made to the foregoing description of the first sub-image, and details are not described herein again. Correspondingly, for the manner of training the pet head portrait plug-in based on the first training image, the description text of the first training image, and the fourth sub-image, reference may be made to the foregoing related description, and details are not described herein again.

In another example, the group of images includes a fifth training image and the aforementioned second training image, and the pet full body portrait plug-in may also be trained by using the second training image, the description text of the second training image, and a fifth sub-image of the fifth training image, where the second training image is used as a training label, and the fifth sub-image includes a full body image of the fifth training image or a full body segmentation of the fifth training image.

For the fifth sub-image, reference may be made to the foregoing description of the second sub-image, and details are not described herein again. Correspondingly, for the manner of training the pet full body portrait plug-in based on the second training image, the description text of the second training image, and the fifth sub-image, reference may be made to the foregoing related description, and details are not described herein again.

In another example, if the group of images includes a sixth training image and the aforementioned third training image, the general plug-in may also be trained by using the third training image, the description text of the third training image, and a sixth sub-image of the sixth training image, where the third training image is used as a training label, and the sixth sub-image includes a full body image of the sixth training image, a full body segmentation of the sixth training image, a head image of the sixth training image, or a head segmentation of the sixth training image.

For the sixth sub-image, reference may be made to the foregoing description of the first sub-image and the second sub-image, and details are not described herein again. Correspondingly, for the manner of training the general plug-in based on the third training image, the description text of the third training image, and the sixth sub-image, reference may be made to the foregoing related description, and details are not described herein again.

Next, the training manners of the aforementioned pet head portrait plug-in and the pet full body portrait plug-in are described with reference to the drawings.

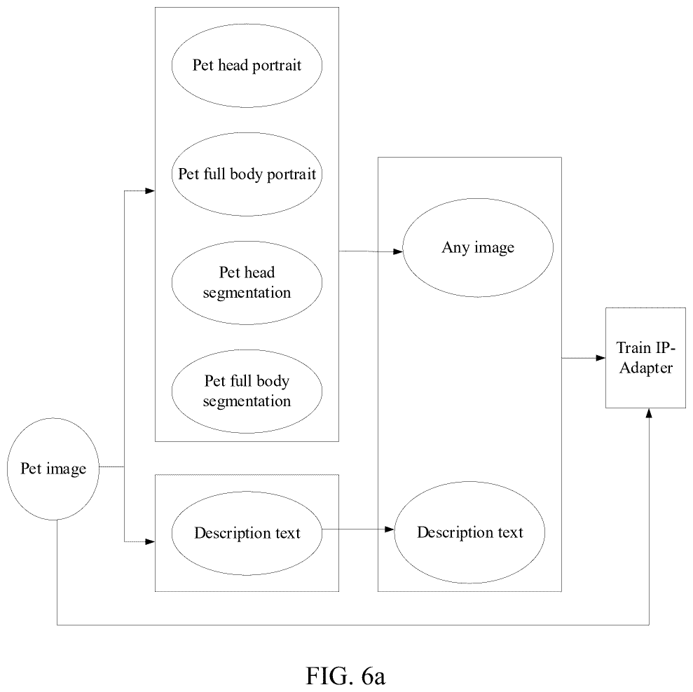

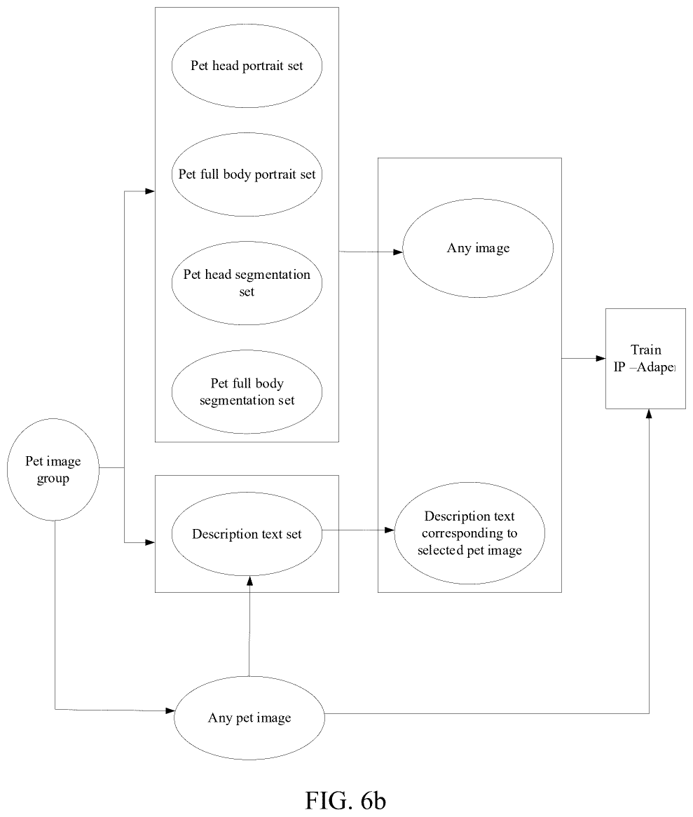

As shown in FIG. 6a, FIG. 6a is a schematic flowchart of a plug-in training method according to an embodiment of the present disclosure.

As shown in FIG. 6a, for a certain pet that has only one pet image that can be used for training, the pet image may be processed to obtain a pet head portrait, a pet full body portrait, a pet head segmentation, and a pet full body segmentation.

The pet head portrait may be an image including a head of the pet that is intercepted from the pet image. The pet head portrait may include some other image backgrounds in addition to the head of the pet.

The pet full body portrait may be an image including a full body of the pet that is intercepted from the pet image. The pet full body portrait may include some other image backgrounds in addition to the full body of the pet.

The pet head segmentation includes the head of the pet, but does not include other image backgrounds.

The pet full body segmentation includes the full body of the pet, but does not include other image backgrounds.

One image may be selected from the pet head portrait, the pet full body portrait, the pet head segmentation, and the pet full body segmentation. The selected pet head portrait may be used as a training head image, the selected pet head segmentation may be used as a training head image, the selected pet full body portrait may be used as a training full body image, and the selected pet full body segmentation may be used as a training full body image.

In addition, the pet image may be used as the first training image.

Further, the IP-Adapter is trained based on an image selected by the user, the pet image, and the description text of the pet image.

As shown in FIG. 6b, FIG. 6b is a schematic flowchart of another plug-in training method according to an embodiment of the present disclosure.

As shown in FIG. 6b, for a certain pet that has a plurality of pet images that can be used for training, the plurality of pet images may constitute a pet image group. Correspondingly, description texts corresponding to the plurality of pet images may constitute a description text group.

For each pet image in the pet image group, the pet image may be processed to obtain a pet head portrait, a pet full body portrait, a pet head segmentation, and a pet full body segmentation. Further, a pet head portrait set including a plurality of pet head portraits, a pet full body portrait set including a plurality of pet full body portraits, a pet head segmentation set including a plurality of pet head segmentations, and a pet full body segmentation set including a plurality of pet full body segmentations are obtained.

Any image may be selected from the pet head portrait set, the pet full body portrait set, the pet head segmentation set, and the pet full body segmentation set. The pet head portrait selected from the pet head portrait set may be used as a training head image, the pet head segmentation selected from the pet head segmentation set may be used as a training head image, the pet full body portrait selected from the pet full body portrait set may be used as a training full body image, and the pet full body segmentation selected from the pet full body segmentation set may be used as a training full body image.

In addition, any pet image is selected from the pet image group as the first training image, and the description text corresponding to the selected pet image is determined from the description text group.

Further, the IP-Adapter is trained based on an image selected by the user, the first training image, and the description text corresponding to the selected pet image.

It should be noted that the training processes in FIG. 6a and FIG. 6b may be combined. For example, when the IP-Adapter is trained, the process shown in FIG. 6a may be used in a certain round of training, and the process shown in FIG. 6b may be used in another round of training.

The IP-Adapter obtained through training by using the above process may be equivalent to the aforementioned general plug-in. In other words, the IP-Adapter obtained through training by using the above process may be used as the pet head portrait plug-in or the pet full body portrait plug-in. In a specific example, two IP-Adapters may be trained by using the above process, one of the IP-Adapters is used as the pet head portrait plug-in, and the other IP-Adapter is used as the pet full body portrait plug-in.

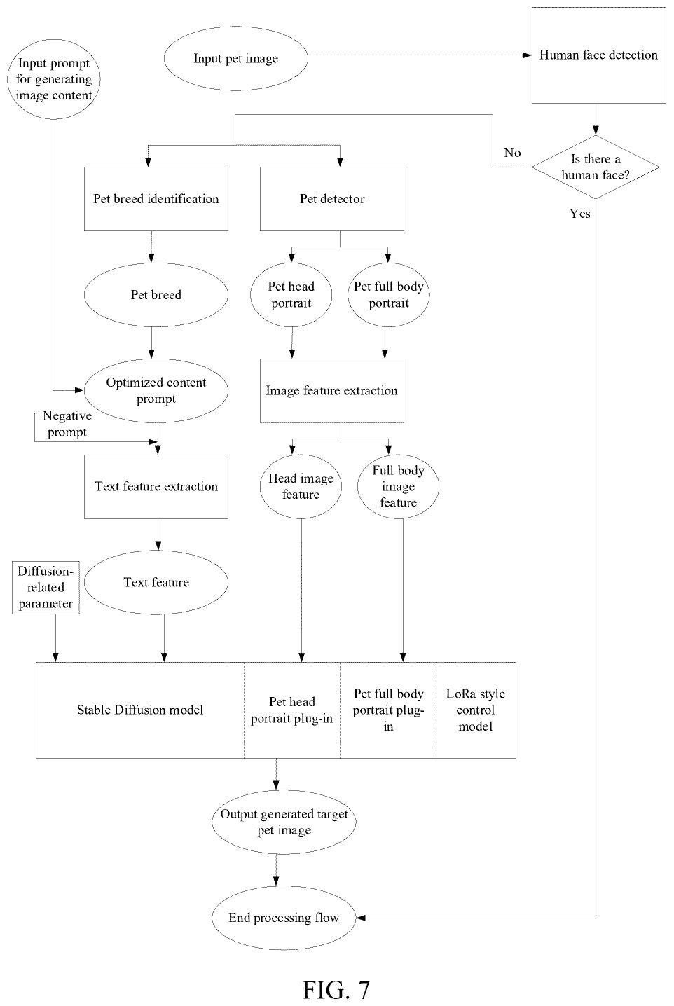

Next, with reference to FIG. 7, the method for generating a pet image provided in the embodiment of the present disclosure is described. FIG. 7 is a schematic flowchart of another method for generating a pet image according to an embodiment of the present disclosure. As shown in FIG. 7:

The user may input a prompt for generating image content, and the prompt for generating image content may be equivalent to the first text mentioned in the above embodiment.

In addition, the user may also input a pet image, and the pet image may be equivalent to the to-be-processed pet image mentioned in the above embodiment.

The client may first detect whether the pet image input by the user includes a human face, and if it is detected that the pet image includes a human face, the processing flow ends. In the case where it is detected that the pet image does not include a human face, the following flow is performed.

The client judges the breed of the pet included in the pet image based on the pet image input by the user. Further, the prompt for generating image content input by the user is optimized based on the obtained breed to obtain an optimized content prompt. In an example, a preset negative prompt may also be added to the optimized content prompt. Further, text features of the optimized content prompt and the negative prompt are extracted, and the text features are input into the Stable Diffusion model. The Stable Diffusion model mentioned here may correspond to the image generation model mentioned in the above embodiments.

In an example, the user may adjust the parameter of the Stable Diffusion model as required.

In addition, a pet detector is used to extract a pet head portrait and a pet full body portrait from the pet image. Further, an image feature extraction technology is used to perform feature extraction on the pet head portrait to obtain a head image feature, and the head image feature is input into the pet head portrait plug-in. In addition, an image feature extraction technology is used to perform feature extraction on the pet full body portrait to obtain a full body image feature, and the full body image feature is input into the pet full body portrait plug-in.

In addition, the LoRa style control model is used as the second plug-in of the Stable Diffusion model. The Stable Diffusion model processes the input text feature and interacts with the pet head portrait plug-in, the pet full body portrait plug-in, and the LoRa style control model to output the generated target pet image.

### Exemplary Device

Based on the method provided in the above embodiment, an embodiment of the present disclosure further provides an apparatus, and the apparatus is described below with reference to the drawings.

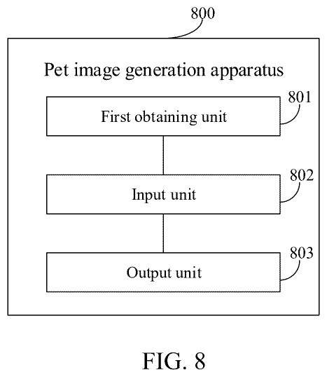

Referring to FIG. 8, FIG. 8 is a schematic diagram of a structure of an apparatus for generating a pet image according to an embodiment of the present disclosure. The apparatus 800 may specifically include a first obtaining unit 801, an input unit 802, and an output unit 803.

The first obtaining unit 801 is configured to obtain a first text input by a user and a to-be-processed pet image input by the user, where the first text indicates a requirement for a to-be-generated target pet image, and the to-be-processed pet image includes a target pet for generating the target pet image; the input unit 802 is configured to input the first text into an image generation model, and input an image feature of the to-be-processed pet image into a pre-trained first plug-in of the image generation model, where the first plug-in is configured to process the image feature, and the image generation model is configured to interact with the first plug-in and process a text input into the image generation model, to generate the target pet image; and the output unit 803 is configured to obtain and output the target pet image output by the image generation model.

Optionally, the first plug-in includes: a pet head portrait plug-in, and/or a pet full body portrait plug-in, and the image feature of the to-be-processed pet image includes a head portrait feature and/or a full body portrait feature; the pet head portrait plug-in is configured to process the head portrait feature of the target pet; and the pet full body portrait plug-in is configured to process the full body portrait feature of the target pet.

Optionally, the pet head portrait plug-in is obtained by training as follows: training the pet head portrait plug-in by using a first training image, a description text of the first training image, and a first sub-image of the first training image, where the first training image is used as a training label, and the first sub-image includes a head image of the first training image or a head segmentation of the first training image, and the first training image is an image including a pet.

Optionally, the pet full body portrait plug-in is obtained by training as follows: training the pet full body portrait plug-in by using a second training image, a description text of the second training image, and a second sub-image of the second training image, where the second training image is used as a training label, and the second sub-image includes a full body image of the second training image or a full body segmentation of the second training image, and the second training image is an image including a pet.

Optionally, the pet head portrait plug-in and the pet full body portrait plug-in are obtained by training as follows: training the pet head portrait plug-in and the pet full body portrait plug-in by using a third training image, a description text of the third training image, and a third sub-image of the third training image, where the third training image is used as a training label, and the third sub-image includes a full body image of the third training image, a full body segmentation of the third training image, a head image of the third training image, or a head segmentation of the third training image, and the third training image is an image including a pet.

Optionally, the apparatus further includes: a first determining unit, configured to identify the to-be-processed pet image to determine a breed of the target pet; and a supplement unit, configured to supplement the first text based on the breed of the target pet to obtain a second text; and the input unit 802 is configured to: input the second text obtained through supplementing the first text into the image generation model.

Optionally, the apparatus further includes: a second obtaining unit, configured to obtain an image style selected by the user, and determine a second plug-in corresponding to the image style, where the second plug-in is configured to control a style of the target pet image; and the image generation model is further configured to: when generating the target pet image, interact with the second plug-in to generate the target pet image.

Optionally, the apparatus further includes: a second determining unit, configured to: before the inputting the first text into an image generation model, and inputting an image feature of the to-be-processed pet image into the first plug-in of the image generation model, determine that the to-be-processed pet image does not include a human face.

Optionally, the to-be-processed pet image is a single pet image.

The apparatus 800 corresponds to the method for generating a pet image provided in the above method embodiments, and the specific implementations of the units of the apparatus 800 are the same as those of the above method embodiments. Therefore, for the specific implementations of the units of the apparatus 800, reference may be made to the related description in the above method embodiments, and details are not described herein again.

An embodiment of the present disclosure further provides an electronic device. The electronic device includes a processor and a memory.

The processor is configured to execute instructions stored in the memory, to enable the electronic device to perform the method for generating a pet image provided in the above method embodiments.

An embodiment of the present disclosure provides a computer-readable storage medium. The computer-readable storage medium includes instructions. The instructions indicate a device to perform the method for generating a pet image provided in the above method embodiments.

An embodiment of the present disclosure further provides a computer program product. When the computer program product runs on a computer, the computer is caused to perform the method for generating a pet image provided in the above method embodiments.

Those skilled in the art will readily conceive of other implementations of the present disclosure after considering the specification and practicing the invention disclosed herein. The present disclosure is intended to cover any variations, uses, or adaptive changes of the present disclosure. These variations, uses, or adaptive changes follow the general principles of the present disclosure and include common general knowledge or conventional technical means in the technical field not disclosed in the present disclosure. The specification and embodiments are only considered as exemplary, and the true scope and spirit of the present disclosure are pointed out by the following claims.

It should be understood that the present disclosure is not limited to the precise structures that have been described and shown in the drawings, and various modifications and changes may be made without departing from the scope of the present disclosure. The scope of the present disclosure is only limited by the appended claims.

The above descriptions are merely preferred embodiments of the present disclosure, and are not intended to limit the present disclosure. Any modification, equivalent replacement, improvement, or the like made within the spirit and principles of the present disclosure shall fall within the protection scope of the present application.

1. A method for generating a pet image, wherein the method comprises:
obtaining a first text input by a user and a to-be-processed pet image input by the user, wherein the first text indicates a requirement for a to-be-generated target pet image, and the to-be-processed pet image comprises a target pet for generating the target pet image;
inputting the first text into an image generation model, and inputting an image feature of the to-be-processed pet image into a pre-trained first plug-in of the image generation model, wherein the first plug-in is configured to process the image feature, and the image generation model is configured to interact with the first plug-in and process a text input into the image generation model, to generate the target pet image; and
obtaining and outputting the target pet image output by the image generation model.

2. The method according to claim 1, wherein the first plug-in comprises:
at least one of a group consisting of a pet head portrait plug-in and a pet full body portrait plug-in, wherein the image feature of the to-be-processed pet image comprises at least one of a group consisting of a head portrait feature and a full body portrait feature;
the pet head portrait plug-in is configured to process the head portrait feature of the target pet; and
the pet full body portrait plug-in is configured to process the full body portrait feature of the target pet.

3. The method according to claim 2, wherein the pet head portrait plug-in is obtained by training as follows:
training the pet head portrait plug-in by using a first training image, a description text of the first training image, and a first sub-image of the first training image, wherein the first training image is used as a training label, and the first sub-image comprises a head image of the first training image or a head segmentation of the first training image, and the first training image is an image comprising a pet.

4. The method according to claim 2, wherein the pet full body portrait plug-in is obtained by training as follows:
training the pet full body portrait plug-in by using a second training image, a description text of the second training image, and a second sub-image of the second training image, wherein the second training image is used as a training label, and the second sub-image comprises a full body image of the second training image or a full body segmentation of the second training image, and the second training image is an image comprising a pet.

5. The method according to claim 2, wherein the pet head portrait plug-in and the pet full body portrait plug-in are obtained by training as follows:
training the pet head portrait plug-in and the pet full body portrait plug-in by using a third training image, a description text of the third training image, and a third sub-image of the third training image, wherein the third training image is used as a training label, and the third sub-image comprises a full body image of the third training image, a full body segmentation of the third training image, a head image of the third training image, or a head segmentation of the third training image, and the third training image is an image comprising a pet.

6. The method according to claim 1, wherein the method further comprises:
identifying the to-be-processed pet image to determine a breed of the target pet; and
supplementing the first text based on the breed of the target pet to obtain a second text; and
the inputting the first text into an image generation model comprises:
inputting the second text obtained through supplementing the first text into an image generation model.

7. The method according to claim 1, wherein the method further comprises:
obtaining an image style selected by the user, and determining a second plug-in corresponding to the image style, wherein the second plug-in is configured to control a style of the target pet image; and
the image generation model is further configured to: when generating the target pet image, interact with the second plug-in to generate the target pet image.

8. The method according to claim 1, wherein before the inputting the first text into an image generation model, and inputting an image feature of the to-be-processed pet image into a pre-trained first plug-in of the image generation model, the method further comprises:
determining that the to-be-processed pet image does not comprise a human face.

9. The method according to claim 1, wherein the to-be-processed pet image is a single pet image.

10. An electronic device, wherein the device comprises a processor and a memory; and
the processor is configured to execute instructions stored in the memory, to enable the device to perform a method for generating a pet image, the method comprising:
obtaining a first text input by a user and a to-be-processed pet image input by the user, wherein the first text indicates a requirement for a to-be-generated target pet image, and the to-be-processed pet image comprises a target pet for generating the target pet image;
inputting the first text into an image generation model, and inputting an image feature of the to-be-processed pet image into a pre-trained first plug-in of the image generation model, wherein the first plug-in is configured to process the image feature, and the image generation model is configured to interact with the first plug-in and process a text input into the image generation model, to generate the target pet image; and
obtaining and outputting the target pet image output by the image generation model.

11. The electronic device according to claim 10, wherein the first plug-in comprises:
at least one of a group consisting of a pet head portrait plug-in and a pet full body portrait plug-in, wherein the image feature of the to-be-processed pet image comprises at least one of a group consisting of a head portrait feature and a full body portrait feature;
the pet head portrait plug-in is configured to process the head portrait feature of the target pet; and
the pet full body portrait plug-in is configured to process the full body portrait feature of the target pet.

12. The electronic device according to claim 11, wherein the pet head portrait plug-in is obtained by training as follows:
training the pet head portrait plug-in by using a first training image, a description text of the first training image, and a first sub-image of the first training image, wherein the first training image is used as a training label, and the first sub-image comprises a head image of the first training image or a head segmentation of the first training image, and the first training image is an image comprising a pet.

13. The electronic device according to claim 11, wherein the pet full body portrait plug-in is obtained by training as follows:
training the pet full body portrait plug-in by using a second training image, a description text of the second training image, and a second sub-image of the second training image, wherein the second training image is used as a training label, and the second sub-image comprises a full body image of the second training image or a full body segmentation of the second training image, and the second training image is an image comprising a pet.

14. The electronic device according to claim 11, wherein the pet head portrait plug-in and the pet full body portrait plug-in are obtained by training as follows:
training the pet head portrait plug-in and the pet full body portrait plug-in by using a third training image, a description text of the third training image, and a third sub-image of the third training image, wherein the third training image is used as a training label, and the third sub-image comprises a full body image of the third training image, a full body segmentation of the third training image, a head image of the third training image, or a head segmentation of the third training image, and the third training image is an image comprising a pet.

15. The electronic device according to claim 10, wherein the method further comprises:
identifying the to-be-processed pet image to determine a breed of the target pet; and
supplementing the first text based on the breed of the target pet to obtain a second text; and
the inputting the first text into an image generation model comprises:
inputting the second text obtained through supplementing the first text into an image generation model.

16. The electronic device according to claim 10, wherein the method further comprises:
obtaining an image style selected by the user, and determining a second plug-in corresponding to the image style, wherein the second plug-in is configured to control a style of the target pet image; and
the image generation model is further configured to: when generating the target pet image, interact with the second plug-in to generate the target pet image.

17. The electronic device according to claim 10, wherein before the inputting the first text into an image generation model, and inputting an image feature of the to-be-processed pet image into a first plug-in of the image generation model, the method further comprises:
determining that the to-be-processed pet image does not comprise a human face.

18. The electronic device according to claim 10, wherein the to-be-processed pet image is a single pet image.

19. A non-transitory computer-readable storage medium, wherein the computer-readable storage medium comprises instructions, and the instructions indicate a device to perform a method for generating a pet image, the method comprising:
obtaining a first text input by a user and a to-be-processed pet image input by the user, wherein the first text indicates a requirement for a to-be-generated target pet image, and the to-be-processed pet image comprises a target pet for generating the target pet image;
inputting the first text into an image generation model, and inputting an image feature of the to-be-processed pet image into a pre-trained first plug-in of the image generation model, wherein the first plug-in is configured to process the image feature, and the image generation model is configured to interact with the first plug-in and process a text input into the image generation model, to generate the target pet image; and
obtaining and outputting the target pet image output by the image generation model.

20. The storage medium according to claim 19, wherein the first plug-in comprises:
at least one of a group consisting of a pet head portrait plug-in and a pet full body portrait plug-in, wherein the image feature of the to-be-processed pet image comprises at least one of a group consisting of a head portrait feature and a full body portrait feature;
the pet head portrait plug-in is configured to process the head portrait feature of the target pet; and
the pet full body portrait plug-in is configured to process the full body portrait feature of the target pet.
